(19) United States
(12) Patent Application Publication
(10) Pub. No.: US 2014/0141354 A1
(43) Pub. Date: May 22, 2014

(54) FUEL CELL ELECTRODE, FUEL CELL MEMBRANE ELECTRODE ASSEMBLY INCLUDING THE ELECTRODE, AND FUEL CELL INCLUDING THE MEMBRANE ELECTRODE ASSEMBLY

(71) Applicant: Samsung Electronics Co., Ltd., Suwon-si (KR)

(72) Inventors: Jung-ock PARK, Yongin-si (KR); Yoon-hoi LEE, Hwaseong-si (KR); Jin-su HA, Cheonan-si (KR); Suk-gi HONG, Seongnam-si (KR)

(21) Appl. No.: 13/917,978

(22) Filed: Jun. 14, 2013

(30) Foreign Application Priority Data
Nov. 21, 2012 (KR) 10-2012-0132602

(51) Int. Cl. H01M 4/86

(52) U.S. Cl. CPC H01M 4/8663
USPC 429/482; 429/523; 429/530; 429/524; 429/525; 429/526; 429/527; 429/532

(57) ABSTRACT

A fuel cell electrode including a catalyst layer including: a catalyst; and a conductor storage material having pores with an average diameter of about 5 nm to about 1000 nm.

### CROSS-REFERENCE TO RELATED APPLICATIONS

This application claims priority to and the benefit of Korean Patent Application No. 10-2012-0132602, filed on Nov. 21, 2012, and all the benefits accruing therefrom under 35 U.S.C. §119, the content of which is incorporated herein in its entirety by reference.

### BACKGROUND

1. Field

The present disclosure relates to a fuel cell electrode, a membrane electrode assembly including the electrode, methods of preparing the same, and a fuel cell including the membrane electrode assembly.

2. Description of the Related Art

One of the alternative energy technologies receiving much attention are fuel cells, which may be categorized as a polymer electrolyte membrane fuel cell (“PEMFC”), a direct methanol fuel cell (“DMFC”), a phosphoric acid fuel cell (“PAFC”), a molten carbonate fuel cell (“MCFC”), or a solid oxide fuel cell (“SOFC”), based on the type of an electrolyte or fuel used.

Of the polymer electrolyte membrane fuel cells (“PEMFC”s), a PEMFC that operates high temperature, i.e., over 100° C. (for example, between a temperature of about 150° C. to about 180° C.), under non-humidifying conditions, and does not use a humidifying device, is known for its high reliability and simple water management because water discharge is easier to control at high temperatures when compared to a PEMFC that operates at a low temperature.

Currently, an acid-doped membrane electrode assembly (“MEA”) is commercialized as a MEA for the high temperature non-humidifying PEMFC, a non-acid doped MEA has not yet been commercialized, and is currently being researched.

In the case of a PEMFC using a phosphoric acid doped MEA, which is a type of acid doped MEA, phosphoric acid that flows into an electrode from an electrolyte membrane acts as an important hydrogen ion conductor, and as a result, it is desirable to disperse the phosphoric acid while maximizing the movement of the fuel in a catalyst layer.

However, during the operation of the fuel cell, the phosphoric acid may leak outside the electrode due to compression in a stack and the fluidity of the phosphoric acid. When the phosphoric acid within the catalyst layer is scarce, the efficiency of the MEA may be reduced because a reaction surface area decreases due to a decrease in reaction surface between a catalyst and phosphoric acid. Thus there remains a need for an improved fuel cell electrode.

### SUMMARY

According to an aspect, there is provided an electrode for a fuel cell wherein a phosphoric acid content may be maintained in a catalyst layer.

According to another aspect, there is provided a method of preparing an electrode for a fuel cell.

According to another aspect, there is provided a membrane electrode assembly for a fuel cell including the fuel cell electrode.

According to another aspect, there is provided a fuel cell including the membrane electrode assembly.

According to an aspect, there is provided a fuel cell electrode including a catalyst and a catalyst layer that includes a catalyst; and a conductor storage material having pores with an average diameter of about 5 nm to about 1000 nm.

Conductivity of the conductor storage material may be over 0.1 Siemens per centimeter (S/cm), and the conductor storage material may be present in the catalyst layer in an amount of about 5 wt % to about 50 wt %, based on 100 wt % of the catalyst.

The conductor storage material has a spherical or a tubular form.

According to an aspect, the conductor storage material may be a carbon fiber having a tubular form having a diameter of about 30 nm to about 100 nm.

The conductor storage material may be at least one of a carbon fiber, and a mesoporous carbon, and an average diameter of pores of the conductor storage material may be about 10 nm to about 200 nm.

The electrode may further include a conductor, or a binder.

The conductor may be at least one selected from phosphoric acid, polyphosphoric acid, phosphonic acid, phosphorous acid, pyrophosphoric acid, tripolyphosphoric acid, tetrapolyphosphoric acid, trimetaphosphoric acid, phosphoric anhydride, and a derivative of the same, and the conductor may be present in an amount of about 10 wt % to about 1000 wt %, based on 100 wt % of the catalyst.

A thickness of the catalyst layer may be about 10 μm to about 100 μm.

According to another aspect, provided is a method of producing a fuel cell electrode, the method including: applying a catalyst layer forming composition including a catalyst and a conductor storage material having an average pore diameter of about 5 nm to about 1000 nm on a surface of a gas diffusion layer; and heat treating the applied layer to form a catalyst layer on the gas diffusion layer and form the fuel cell electrode.

According to another aspect, provided is a membrane electrode assembly for a fuel cell including the fuel cell electrode.

According to another aspect, provided is a fuel cell including the membrane electrode assembly.

The electrode for the fuel cell according to an aspect provides improved durability and improved conductor content in the catalyst layer.

### BRIEF DESCRIPTION OF THE DRAWINGS

These and/or other aspects will become apparent and more readily appreciated from the following description of the aspects, taken in conjunction with the accompanying drawings in which:

FIG. 1 is a schematic diagram of an embodiment of a membrane electrode assembly (“MEA”) including a fuel cell electrode;

FIG. 2 is an exploded oblique view showing a structure of an embodiment of a fuel cell;

FIG. 3 is a cross-sectional schematic diagram of an embodiment of a MEA of the fuel cell of FIG. 2;

FIG. 4 is a scanning electron microscope (“SEM”) image of an embodiment of a carbon fiber used in an embodiment;

FIG. 5 is a transmission electron microscope (“TEM”) image of an embodiment of a carbon fiber used in another embodiment;

FIG. 6 is a SEM image of a cathode catalyst layer prepared according to Example 1;

FIG. 7 is a TEM image of a cathode catalyst layer prepared according to Example 1;

FIG. 8 is a histogram of phosphoric acid content (percent, %) showing changes in phosphoric acid content after applying pressure to a MEA prepared according to Example 2 and Comparative Example 1;

FIG. 9 is a graph of cell voltage (volts, V) versus current density (amperes per square centimeter, A/cm²) showing changes in cell voltage according to current density of a MEA prepared according to Example 1 and Example 3; and

FIG. 10 is a graph of cell voltage (percent of peak, %) versus time (hours) showing a lifetime of a MEA prepared according to Examples 2 and 3, and Comparative Example 1.

### DETAILED DESCRIPTION

Reference will now be made in detail to aspects, examples of which are illustrated in the accompanying drawings, wherein like reference numerals refer to like elements throughout. In this regard, the present aspects may have different forms and should not be construed as being limited to the descriptions set forth herein. Accordingly, the aspects are merely described below, by referring to the figures, to explain aspects of the present description. Expressions such as “at least one of,” when preceding a list of elements, modify the entire list of elements and do not modify the individual elements of the list.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer,” or “section” discussed below could be termed a second element, component, region, layer, or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

“Alkyl” means a straight or branched chain, saturated, monovalent hydrocarbon group (e.g., methyl or hexyl).

“Cycloalkyl” means a monovalent group having one or more saturated rings in which all ring members are carbon (e.g., cyclopentyl and cyclohexyl).

“Aryl” means a monovalent group formed by the removal of one hydrogen atom from one or more rings of an arene (e.g., phenyl or naphthyl).

“Arylalkyl” means a substituted or unsubstituted aryl group covalently linked to an alkyl group that is linked to a compound (e.g., a benzyl is a C7 arylalkyl group).

The fuel cell electrode includes a catalyst layer including a catalyst; and a conductor storage material having pores having an average diameter of about 5 nanometers (nm) to about 1000 nm.

An average diameter of the pores of the conductor storage material may be, for example, about 10 nm to about 200 nm, specifically between about 10 nm to about 100 nm. When the average pore diameter is within this range, a conductor retention efficiency of the conductor storage material is excellent, and a conductor may be efficiently replenished while a fuel cell including an electrode including the catalyst layer operates. In detail, when the fuel cell operates for a long time, phosphoric acid from the conductor storage material may be supplemented in the catalyst layer to help in maintaining the efficiency of a membrane electrode assembly (“MEA”).

The conductor storage material may comprise any suitable material having pores that may store the conductor. The conductor storage material may comprise any suitable carbon, which may be amorphous or crystalline, and may comprise at least one selected from carbon nanotubes, carbon fiber, mesoporous carbon, and mesocarbon microbeads. The carbon nanotubes may be hollow and have a linear fullerene structure. The carbon nanotubes may comprise single-wall carbon nanotubes or multi-wall carbon nanotubes. A combination comprising at least one of the foregoing may be used. The conductor storage material may have any suitable shape, and, for example, the conductor storage material may have a tubular form or a spherical form.

An example of a conductor storage material having a tubular form may be a carbon fiber, and an example of a conductor storage material having a spherical form may be a porous carbon, for example, an ordered mesoporous carbon. The ordered mesoporous carbon may have a diameter of about 300 nanometers to about 5000 nanometers.

According to an aspect, the conductor storage material may have a tubular form having a diameter of about 30 nm to about 5000 nm, specifically about 60 nm to about 4000 nm, more specifically about 180 nm to about 3000 nm, and optionally a length of about 500 nanometers to about 15000 nanometers, specifically about 1000 nanometers to about 10000 nanometers. When a conductor storage material in a tubular form having a diameter in this range is used, the conductivity of the catalyst layer may be excellent and a binding strength of the catalyst layer on the gas diffusion layer may be well maintained.

The conductor storage material is included in the catalyst layer such that a proton conductor, such as phosphoric acid, may be directly supplied to a space between catalyst particles, thereby further enhancing an electrode reaction compared to when the phosphoric acid is supplied to some other location.

An average diameter of the pores of the conductor storage material is greater than an average diameter of a pore between the catalyst particles. While not wanting to be bound by theory, it is understood that when the conductor storage material having an average pore diameter greater than an average pore diameter of pores between the catalyst particles is used, a conductor stored in the conductor storage material may flow into a pore between catalyst primary particles by capillary action.

The pore between the catalyst particles is defined as the pore between the catalyst primary particles, and it may be measured by a gas absorption method using nitrogen or argon. See, for example, E. P. Barrett, L. G. Joyner, P. P. Halenda, The determination of pore volume and area distributions in porous substances. I. Computations from nitrogen isotherms, J. Am. Chem. Soc. (1951), 73, 373-380.

According to an aspect, the average distance between the catalyst primary particles is about 10 nm to about 30 nm, specifically about 15 nm to about 25 nm, and the average diameter of the pores of the conductor storage material is about 10 nm to about 200 nm, specifically about 20 nm to about 180 nm, more specifically about 30 nm to about 160 nm, and is greater than the average diameter of the pores between the catalyst primary particles.

The conductor storage material may have a suitable resistance to decay and have a pore or a hole capable of storing a conductor such as phosphoric acid. As an example of such a material, at least one of a carbon fiber and an ordered mesoporous carbon may be selected.

The carbon fiber conductor storage material may have a diameter of, for example, about 300 nm to about 5000 nm, specifically about 400 nm to about 4000 nm, and a length of 500 nm to about 15000 nm, for example about 9000 nm to about 10000 nm, and an average diameter of the pores may be about 10 nm to about 100 nm, and an aspect ratio (diameter/length) of about 0.03 to about 0.6. When diameter, length, average diameter of the pores, and aspect ratio of the carbon fiber are within these ranges, the ability of the carbon fiber to maintain a content of the conductor, such as phosphoric acid, and suitably provide the conductor to the catalyst layer, are excellent.

The conductivity of the conductor storage material may be 0.1 Siemens per centimeter (S/cm) or more, for example, about 0.1 S/cm to about 100 S/cm, and as a result, conductivity of the electrode is excellent even if the conductor storage material is added to the catalyst layer.

The content of the conductor storage material in the catalyst layer may be about 5 to about 50 parts by weight, for example, about 6 parts by weight to about 15 parts by weight, based on 100 parts by weight of the catalyst. When the content of the conductor storage material is within this range, the efficiency and the durability of the fuel cell using the electrode are excellent.

The conductor may, for example, include a phosphoric acid based material.

As the phosphoric acid based material, phosphoric acid (also known as orthophosphoric acid, (H₃PO₄)), polyphosphoric acid (Hₙ₊₃PₙO₃ₙ), phosphonic acid (RPO₃H₂ wherein R is a C1 to C18 alkyl, C3 to C8 cycloalkyl, C4 to C18 aryl, or C7 to C30 arylalkyl group), phosphorous acid (H₃PO₃), pyrophosphoric acid (H₄P₂O₇), tripolyphosphoric acid (H₅P₃O₁₀), tetrapolyphosphoric acid (H₆P₄O₁₃), trimetaphosphoric acid (H₃P₃O₉), phosphoric anhydride (P₄O₁₀), and the derivatives of the same, e.g., the C1 to C18 alkyl, C3 to C8 cycloalkyl, C4 to C18 aryl, or C7 to C30 arylalkyl substituted esters of the foregoing acids, or salts of the foregoing acids, may be used. Phosphoric acid is specifically mentioned.

The concentration of the phosphoric acid based material may be about 80 weight percent (wt %) to about 100 wt %, for example, about 85 wt % to about 95 wt %.

The thickness of the catalyst layer may be about 10 μm to about 100 μm. When the thickness of the catalyst layer is within this range, the efficiency of the cell is excellent because an enhanced catalytic reaction occurs in the electrode.

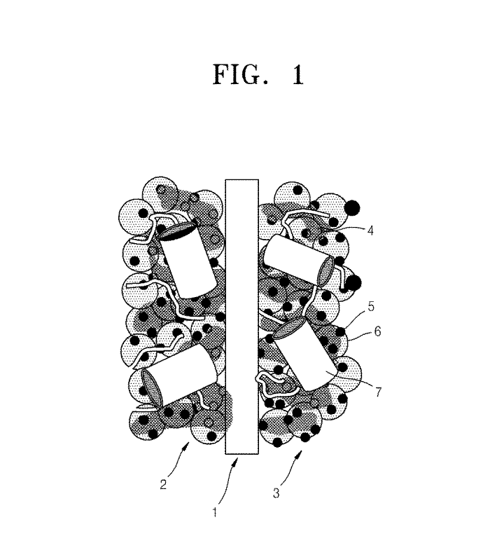

FIG. 1 is a schematic diagram of a fuel cell electrode.

As shown in FIG. 1, on one side of an electrolyte membrane 1 there is a cathode catalyst layer 2 and on the other side there is an anode catalyst layer 3. The cathode catalyst layer 2 and the anode catalyst layer 3 each include a catalyst 5, a support 6 having the catalyst 5 disposed thereon, and a conductor storage material 7, respectively. The conductor storage material 7 includes a conductor, for example, phosphoric acid 4, and while the fuel cell operates, or is being turned on or off, the phosphoric acid transports out of the conductor storage material 7, such that it replenishes phosphoric acid in the cathode catalyst layer 2 and/or the anode catalyst layer 3. When the phosphoric acid is replenished, suitable phosphoric acid content is maintained in the cathode catalyst layer 2 and the anode catalyst layer 3, such that a reaction surface between the catalyst and the phosphoric acid is sufficiently provided, and a suitable catalytic reaction may be maintained.

While not wanting to be bound by theory, it is understood that in the conductor storage material 7, where the phosphoric acid transports from the conductor storage material when the fuel cell is turned on or off, the phosphoric acid may retain water when the fuel cell stops operating because the phosphoric acid has a high affinity for water, and as a result, a movement of the phosphoric acid may be facilitated such that the phosphoric acid content may be suitably maintained within the electrode. Also, because the average diameter of the pores of the conductor storage material 7 is greater than an average diameter of the pores between the catalyst primary particles, the phosphoric acid in the conductor storage material 7 may be induced to disperse into the catalyst by capillary action. Hence, while driving or turning on or off the membrane electrode assembly, the phosphoric acid may be rapidly disposed to a space between the pores of the catalyst layer, providing a proton conductive pathway, and may provide a pathway, e.g., open porosity, for moving a gaseous fuel. As a result, the phosphoric acid is sufficiently replenished in the electrode catalyst layer, improving the efficiency and the durability of the fuel cell.

Hereinafter, a method of preparing an electrode for a fuel cell is further disclosed.

A catalyst layer is formed by applying a catalyst layer forming composition including a catalyst and a conductor storage material having an average pore diameter of about 5 nm to about 1000 nm on a top surface of a gas diffusion layer, and then heat treating the resulting structure.

The catalyst layer forming composition may further include a binder.

The binder may include at least one selected from a fluorinated polymer, benzimidazole polymer, polyimide, polyether imide, polyphenylene sulfide, polysulfone, polyether sulfone, polyether ketone, polyether-ether ketone, and polyphenylquinoxaline.

The binder, for example, may include at least one selected from a poly(vinylidenefluoride), polytetrafluoroethylene, and a tetrafluoroethylene-hexafluoroethylene copolymer.

The content of the binder may be about 1 part by weight to about 50 parts by weight, specifically about 2 parts by weight to about 25 parts by weight, based on 100 parts by weight of the catalyst.

If the binder content is within this range, the binding strength of the catalyst layer with respect to the gas diffusion layer is excellent.

A conductor may further be included in the composition for forming the catalyst layer.

The conductor may comprise a phosphoric acid based material. The content of the conductor may be about 10 parts by weight to about 100 parts by weight, specifically about 20 parts by weight to about 80 parts by weight, based on 100 parts by weight of the catalyst.

The catalyst may include at least one element selected from platinum (Pt), palladium (Pd), ruthenium (Ru), iridium (Ir), Osmium (Os), a platinum (Pt)-palladium (Pd) alloy, a platinum (Pt)-ruthenium (Ru) alloy, a platinum (Pt)-iridium (Ir) alloy, a platinum (Pt)-osmium (Os) alloy, and a platinum (Pt)-M alloy (wherein M is at least one element selected Ga, Ti, V, Cr, Mn, Fe, Co, Ni, Cu, Ag, Au, Zn, Sn, Mo, W, and Rh).

A supported catalyst, wherein the catalyst is disposed on a carbon based support may be used. The carbonaceous support may be amorphous or graphitic, and may be heat treated to increase its corrosion resistance. The carbonaceous support may have a Brunauer, Emmett and Teller (BET) surface area of 50 m²/g to about 2000 m²/g, specifically 500 m²/g to about 1500 m²/g. The carbonaceous support may have an average particle size of about 10 nanometers (nm) to about 500 nm, for example about 30 nm to about 400 nm. Any suitable carbon may be used for the carbonaceous support, e.g., ketjen black, carbon black, graphite, carbon nanotubes, carbon fiber, mesoporous carbon, mesocarbon microbeads, oil furnace black, extra-conductive black, acetylene black, or lamp black.

A method of coating the gas diffusion layer surface with the catalyst forming composition is not specifically limited. Any suitable method, such as coating using a doctor blade, bar coating, or a screen printing method may be used.

Coating and heat treating of the catalyst layer forming composition may be performed in a temperature range of about 20° C. to about 150° C., specifically about 30° C. to about 140° C. If the heat treating time varies corresponding to the heat treating temperature, the heat treating may be performed for about 10 minutes to about 60 minutes, specifically about 20 minutes to about 50 minutes.

According to an aspect, if a conductor is added to the catalyst forming composition, the electrode obtained according to the method above may be impregnated with the conductor.

According to an aspect, the electrode is a positive electrode.

The fuel cell electrode obtained according to the method above may be combined with an electrolyte membrane.

Any electrolyte membrane suitable for use in a fuel cell may be used for the electrolyte membrane. For example, the electrolyte membrane may comprise at least one selected from a polybenzimidazole electrolyte membrane, a polybenzoxazine-polybenzimidazole copolymer electrolyte membrane, and a poly(tetrafluoroethylene) (“PTFE”) porous membrane may be used.

The electrolyte membrane may be impregnated with the conductor. The type of the conductor is the same as that in the electrode described above.

The MEA includes a cathode, an anode located opposite to the cathode, and an electrolyte membrane located in between the cathode and the anode, and at least one of the cathode and the anode includes the electrode for the fuel cell.

According to another aspect, a fuel cell including the MEA is provided.

The fuel cell, for example, may be a polymer electrolyte membrane fuel cell (“PEMFC”), a phosphoric acid fuel cell (“PAFC”), or a direct methanol fuel cell (“DMFC”).

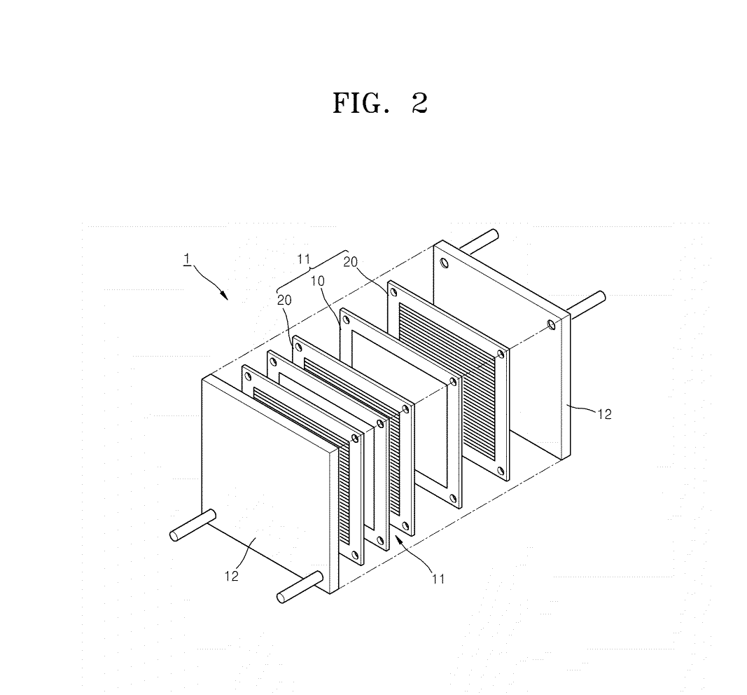

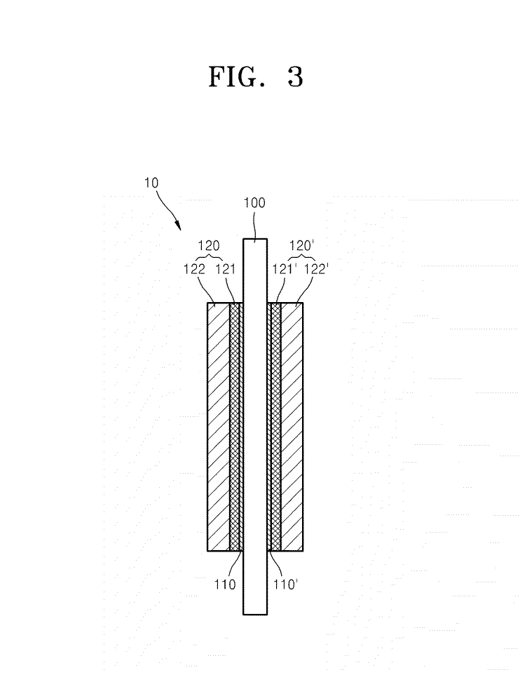

FIG. 2 is an exploded oblique view showing an embodiment of a fuel cell, and FIG. 3 is a cross-sectional schematic diagram of a MEA of the fuel cell of FIG. 2.

The fuel cell shown in FIG. 2 comprises two unit cells 11 held between a pair of holders 12. Each of the unit cells 11 includes a MEA 10, and a bipolar plate 20, respectively located on both sides of the MEA 10. The bipolar plates 20 comprise a conductive metal or carbon and each contact the MEA 10, act as a current collector, and provide air and fuel to the catalyst layer.

Also, although there are two unit cells 11 in the fuel cell in FIG. 2, the number of unit cells is not limited to two, and may be tens to hundreds, e.g., 1 to about 1000, as desired.

The MEA 10, as shown in FIG. 3 includes an electrolyte membrane 100, first and second catalyst layers 110 and 110′, respectively located on opposite sides of the electrolyte membrane 100, and first and second microporous layers 121 and 121′ respectively disposed on each of the first and second catalyst layers 110 and 110′, and first and second gas diffusion layers 120 and 120′, each of which include first and second scaffolds 122, and 122′.

The gas diffusion layers 120 and 120′ may disperse air and fuel, respectively, to the entire surface of the catalyst layers 110 and 110′, respectively, through the bipolar plates 20, and rapidly discharge water formed in the catalyst layers 110 and 110′.

Also, the catalyst layers 110 and 110′ desirably have suitable electrical conductivity.

The first and second gas diffusion layers 120 and 120′ respectively include first and second microporous layers 121 and 121′, and first and second supporting substrates 122 and 122′. The supporting substrates 122 and 122′ may comprise a conductive material, such as a metal or a carbon based material. For example, conductive substrates such as carbon paper, carbon cloth, carbon felt, or metal cloth may be used, but are not limited thereto.

The microporous layers 121 and 121′ may include a conductive powder having a small particle diameter, for example, carbon powder, carbon black, acetylene black, active carbon, carbon fiber, fullerene, carbon nanotube, carbon nanowire, carbon nano-horn, or carbon nano-ring may be included. If a particle size of the conductive powder of the microporous layers 121 and 121′ is too small, insufficient gas diffusion may result, and if the diameter is too large, uniform gas dispersion may be difficult. Thus, to provide suitable gas diffusion, a conductive powder having an average particle diameter of about 10 nm to about 50 nm may be used.

As the gas diffusion layers 120 and 120′, commercial products may be used, or the gas diffusion layers may be prepared by purchasing the carbon papers and directly coating microporous layers 121 and 121′ thereon. Gas diffusion occurs through a space between a pore formed between the conductive powder particles of the microporous layers, and the average diameter of the pores is not specifically limited. For example, the average diameter of the pores of the microporous layers 12 may be in a range of about 1 nm to about 10 μm. For example, the average diameter of the pores may be in range of about 5 nm to about 1 μm, about 10 nm about 500 nm, or about 50 nm to about 400 nm.

To provide suitable gas diffusion and electrical resistance, the thickness of the gas diffusion layers 120 and 120′ may be in a range of about 200 μm to about 400 μm. For example, the thickness of the gas diffusion layers 120 and 120′ may be about 100 μm to about 350 μm, and more specifically, may be about 200 μm to about 350 μm.

The catalyst layers 110 and 110′ may respectively act as a fuel electrode, and an oxygen electrode, and may respectively include the conductor storage material, and the catalyst.

The catalyst layers 110 and 110′ efficiently activate the electrode reaction, and to prevent an undesirable increase in the electrical resistance, the thickness of the catalyst layers may be about 10 μm to about 100 μm. For example, the catalyst layer 14 may have a thickness of about 20 μm to about 60 μm, and more specifically, the thickness may be about 30 μm to about 50 μm.

The catalyst layers 110 and 110′ may further include a binder to increase adhesion of the catalyst layers, and to transfer hydrogen ions.

The catalyst layers 110 and 110′, microporous layers 121 and 121′, and scaffolds 122 and 122′ may be arranged closely to each other, and may further include a layer, which has a different function, between the layers if desired. These layers may form a cathode and an anode of the MEA.

An electrode membrane 100 is disposed on the catalyst layers 110 and 110′. The electrolyte membrane is not specifically limited, and may comprise at least one of polymer electrolyte membrane selected from a polybenzimidazole (“PBI”), cross-linked polybenzimidazole, poly(2,5-benzimidazole) (“ABPBI”), polyurethane, and modified polytetrafluoroethylene (“PTFE”).

In the electrolyte membrane 100, phosphoric acid or an organic phosphoric acid is impregnated, and an acid other than the phosphoric acid may be used. For example, in the electrolyte membrane 100, phosphoric acid based materials such as phosphoric acid, polyphosphoric acid, phosphonic acid, phosphorous acid, pyrophosphoric acid, tripolyphosphoric acid, tetrapolyphosphoric acid, trimetaphosphoric acid, phosphoric anhydride, and the derivatives of the same, may be impregnated.

The concentration of the phosphoric acid based material is not specifically limited, and a concentration of a phosphoric acid solution may be at least 80 wt %, 90 wt %, 95 wt %, or 98 wt %, for example, about 80 wt % to about 99 wt %. A phosphoric solution with a concentration of about 80 wt % to about 100 wt % may be used.

According to another aspect, the fuel cell includes the MEA.

The fuel cell including the membrane-electrode assembly may operate under a temperature of about 100° C. to about 300° C., and as shown in FIG. 2, a fuel, for example, hydrogen is supplied through a bipolar plate 20 on one side of the catalyst layers, and on the other catalyst layer, hydrogen is oxidized to hydrogen ions (H⁺) through a bipolar plate 20. Also, regarding one catalyst layer, hydrogen is oxidized to hydrogen ions (H⁺), and these hydrogen ions (H⁺) are conducted through the electrolyte membrane 100 and reach the other catalyst layer, and on the other catalyst layer, hydrogen ions (H⁺) and oxygen electrochemically react to produce water (H₂O), and electrical energy simultaneously. Also, hydrogen supplied as a fuel may be hydrogen produced by reforming hydrocarbon or alcohol, and the oxygen supplied as an oxidizing agent may be supplied as that included in air.

### EXAMPLES

### Preparation Example 1

### Manufacture of a Polybenzoxazine Compound Solution

In 2 grams (g) of a compound of Formula 1 (“4FPh2AP”), 200 g of 85 weight percent (wt %) phosphoric acid aqueous solution was added, and the mixture was mixed at a temperature of 80° C. for an hour to obtain a phosphoric acid solution of 4FPh2AP, and the solution was heat treated at a temperature of 160° C. to perform polymerization.

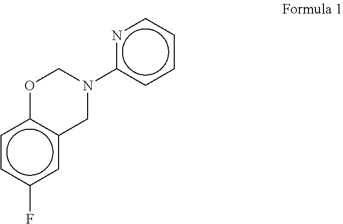

A product of the polymerization was centrifuged to remove the phosphoric acid, and was washed with water, and water was added to obtain a polybenzoxazine based compound aqueous solution including approximately 5 wt % polybenzoxazine based compound particles.

### Example 1

### MEA Preparation

A cathode was prepared by coating a catalyst slurry including 1 g of a carbon supported platinum-cobalt catalyst PtCo/C, 0.06 g of tubular form carbon fiber, 4 g of N-methylpyrrolidone (“NMP”), and the binder, which is a polybenzoxazine based aqueous solution (5 wt % in H₂O) obtained according to Preparation Example 1 onto a mesoporous layer coated with a gas diffusion layer formed of Ketjen Black and having a thickness of approximately 40 μm, and drying the result in an oven for an hour at a temperature of 80° C., and for 10 minutes at a temperature of 150° C.

A diameter of the carbon fiber was about 500 nm, and a length of the carbon fiber was about 10 μm (10000 nm), a pore diameter of the carbon fiber was about 50 nm, and an aspect ratio of the carbon fiber was about 0.05. The electrical conductivity of the carbon fiber was about 10 S/cm, and its content was about 6 parts by weight of 100 parts by weight of a carbon supported platinum-cobalt catalyst, PtCo/C.

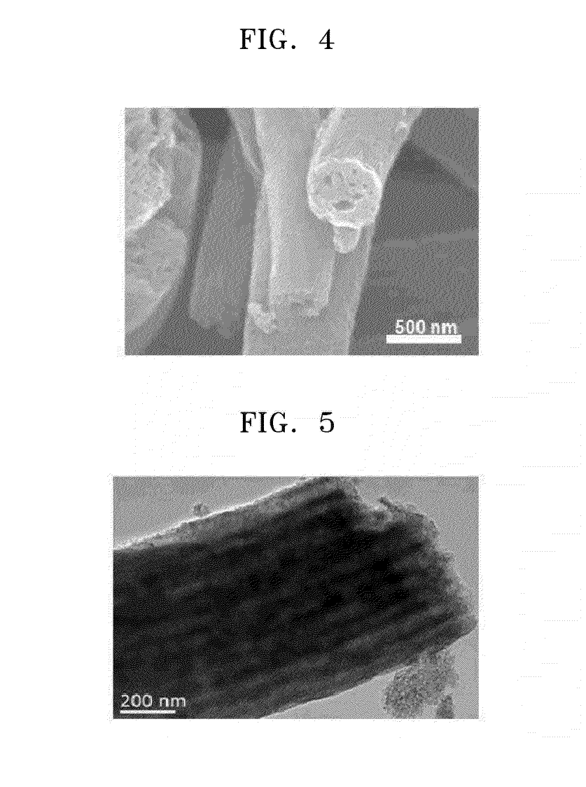

Based on the SEM image of FIG. 3, and TEM image of FIG. 4, the carbon fiber has a tubular form, and the diameter, the length, and the pore diameter of the carbon fiber were determined.

Separately, an anode was prepared according to the method below.

2 g of a supported catalyst including 50 wt % Pt, and 9 g of the solvent NMP were added to carbon and the mixture was agitated for two minutes using a high speed agitator. Thereafter, a solution where 0.05 g of polyvinylidene fluoride dissolved in 0.95 g NMP was added to the mixture, and further agitated for 2 minutes, thereby preparing slurry for forming an anode catalyst layer. The slurry was coated on a carbon paper coated with a microporous layer using a bar coater.

Separately, 50 parts by weight of a mixture (“PPO”) represented by Formula 2, and 50 parts by weight of polybenzimidazole (“m-PBI”) represented by Formula 3 were blended, and the product was cured in a temperature range of about 80° C. to about 220° C.

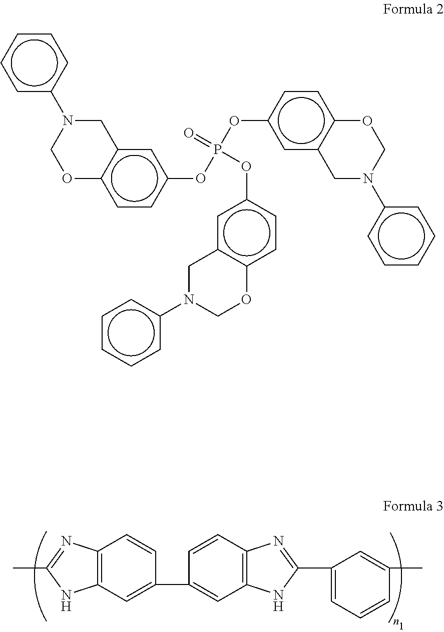

In Formula 3, n₁ is about 130. Furthermore, the product was prepared by impregnating with 85 wt % of phosphoric acid on the product of Formula 3 for over 4 hours at a temperature of about 80° C. to form an electrolyte membrane. Herein, the content of the phosphoric acid was about 500 parts by weight, based on 100 parts by weight of the total weight of the electrolyte membrane.

MEA was prepared by interposing the electrolyte membrane between the cathode and the anode.

### Example 2

### Preparing MEA

The same manufacturing method as in Example 1 was used to manufacture a MEA, except for using 0.1 g of carbon fiber when forming a cathode catalyst layer. In the cathode catalyst layer, the content of the carbon fiber was 10 parts by weight of 100 parts by weight of the PtCo/C catalyst.

### Example 3

### Preparing MEA

The same manufacturing method as in Example 1 was used to prepare a MEA, except for using 0.15 g of carbon fiber when forming a cathode catalyst layer. The content of the carbon fiber was 15 parts by weight of 100 parts by weight of the PtCo/C catalyst.

### Example 4

### Preparing MEA

The same manufacturing method as in Example 1 was used to prepare a MEA, except 0.1 g of an ordered mesoporous carbon (“OMC”) was used instead of 0.1 g of carbon fiber. The content of the OMC was 6 parts by weight of 100 parts by weight of a catalyst PtCo/C.

An average diameter of the pores of the OMC was about 30 nm.

### Comparative Example 1

### Preparing MEA

The same manufacturing method as in Example 1 was used to prepare a MEA, except a carbon fiber was not used when forming a cathode catalyst layer.

### Evaluation Example 1

### SEM and TEM Analyses

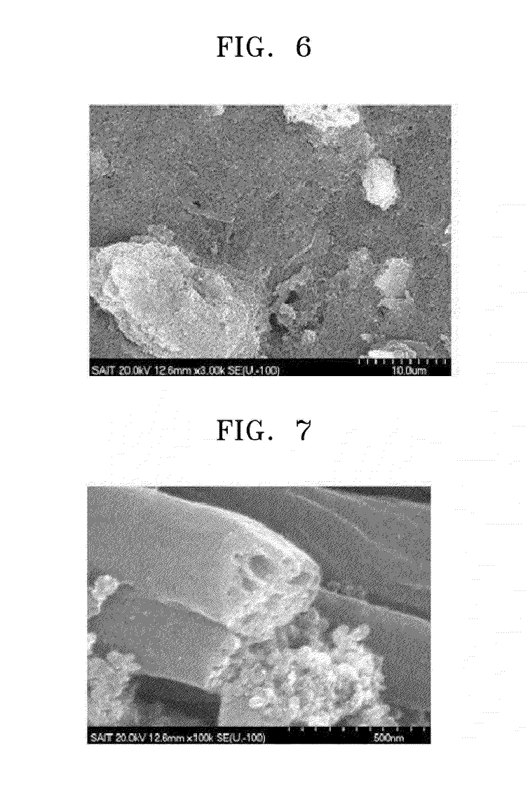

A SEM image of the cathode catalyst layer prepared according to Example 1 was analyzed, and the result is shown in FIG. 6. And TEM analysis of the cathode catalyst layer is shown in FIG. 7.

As shown in FIG. 7, the carbon fiber included in the cathode catalyst layer has pores, and this carbon fiber corresponds to white region in FIG. 6.

### Evaluation Example 2

### An Analysis of Phosphoric Acid Retention Capacity in MEA after Applying Pressure to a MEA

MEA prepared according to Example 2, and Comparative Example 1 was pressed and its phosphoric acid retention was evaluated according to a method described below.

On top and at the bottom of the MEA (thickness: about 850 μm) prepared according to Example 2, and Comparative Example 1, sub-gaskets (thickness: about 220 μm) were located to prepare a structure, and a pressure of at 4900 kiloPascals (kPa) was applied for 20 minutes such that the thickness of the MEA may be 440 μm.

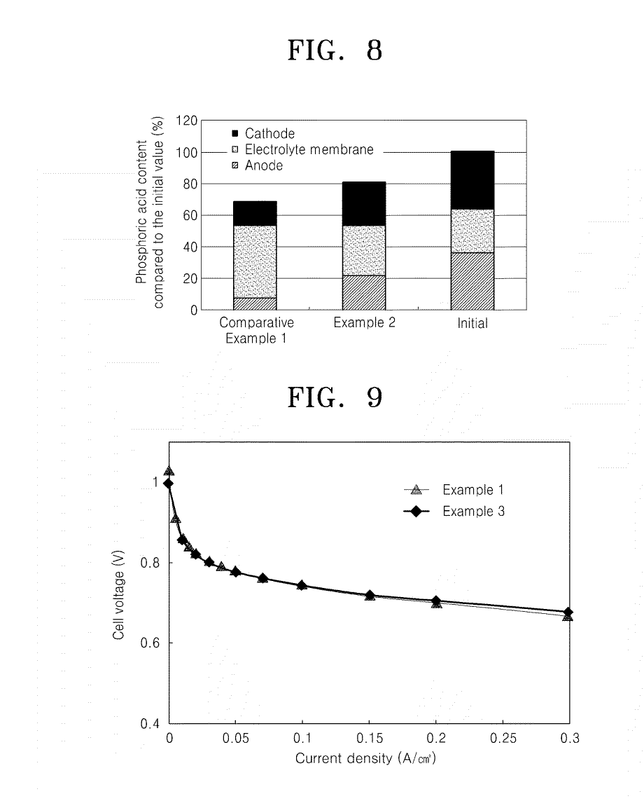

Thereafter, the structure was dismantled thereby separating the MEA into an electrolyte membrane, a cathode, and an anode, and changes in terms of phosphoric acid content at the anode and the cathode were investigated and are shown in FIG. 8. In FIG. 8, “initial” represents the phosphoric acid content impregnated on a cathode, an electrolyte membrane, and an anode before pressing the MEA prepared according to Example 2, and Comparative Example 1.

As shown in FIG. 8, the MEA of Example 2 has greater phosphoric acid retention capacity after pressure is applied compared to Comparative Example 1.

### Evaluation Example 3

### Cell Efficiency Analysis

To investigate cell efficiency of the MEA according to Example 1, and Example 3, the cell was operated by flowing about 250 cubic centimeters per minute (ccm) of air over a cathode, and 100 ccm of hydrogen over an anode in each MEA, under non-humidifying conditions at a temperature of 150° C.

The active surface areas of the cathode and the anode were about 7.84 cm².

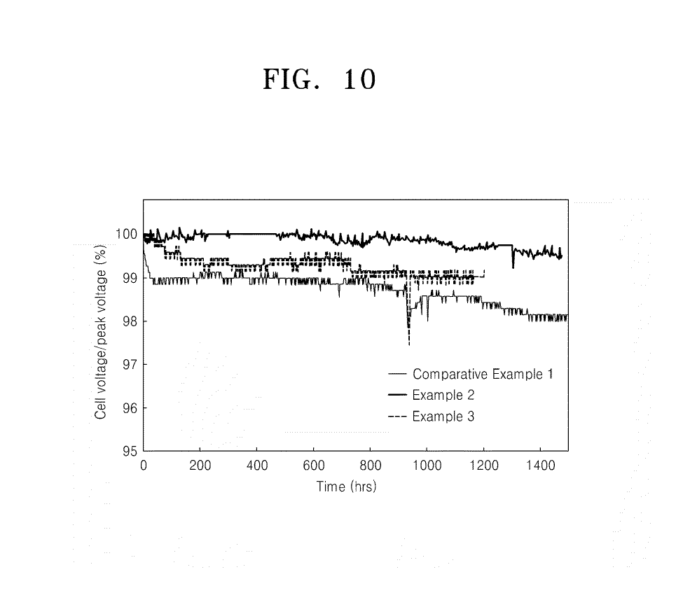

Changes in cell voltage corresponding to current density of the MEA were investigated and the results are shown in FIG. 9.

As shown in FIG. 9, the membrane electrode assembly of Example 1, and Example 3 has excellent cell efficiency.

### Evaluation Example 4

### Lifetime Analysis

To investigate the cell efficiency of the MEA prepared according to Example 2, Example 3, and Comparative Example 1, the cell was operated by flowing about 250 ccm of air over a cathode, and about 100 ccm of hydrogen over an anode in each MEA, under non-humidifying conditions at a temperature of 150° C.

The active surface areas of the cathode and the anode were about 7.84 cm².

In the membrane electrode assembly, the ratio of peak voltage to cell voltage corresponding to driving time under 0.2 A/cm² was investigated and shown in FIG. 10.

As shown in FIG. 10, the MEA prepared in Example 2 and in Example 3 has a reduced voltage loss over time, i.e., improved voltage stability, compared to Comparative Example 1.

It should be understood that the exemplary aspects described herein should be considered in a descriptive sense only and not for purposes of limitation. Descriptions of features, advantages, or aspects within each aspect should typically be considered as available for other similar features or aspects in other aspects.

What is claimed is:

1. A fuel cell electrode comprising a catalyst layer comprising:
a catalyst; and
a conductor storage material comprising pores with an average diameter of about nm to about 1000 nm.

2. The electrode of claim 1, wherein a conductivity of the conductor storage material is 0.1 Siemens per centimeter or more.

3. The electrode of claim 1, wherein a content of the conductor storage material in the catalyst layer is about 5 to about 50 parts by weight, based on 100 parts by weight of the catalyst.

4. The electrode of claim 1, wherein an average pore diameter of the pores of the conductor storage material is about 10 nanometers to about 200 nanometers.

5. The electrode of claim 1, wherein an average pore diameter of the pores of the conductor storage material is greater than an average pore diameter of pores between primary particles of the catalyst.

6. The electrode of claim 1, wherein the conductor storage material has a spherical or a tubular form.

7. The electrode of claim 1, wherein the conductor storage material is at least one selected from carbon fiber and ordered mesoporous carbon.

8. The electrode of claim 1, wherein the conductor storage material is
an ordered mesoporous carbon having a diameter of about 300 nanometers to about 5000 nanometers, or
a tubular carbon fiber having a diameter of about 300 nanometers to about 5000 nanometers and a length of about 500 nanometers to about 15000 nanometers.

9. The electrode of claim 1, further comprising a conductor disposed in the catalyst layer.

10. The electrode of claim 9, wherein the conductor is at least one selected from phosphoric acid, polyphosphoric acid, phosphonic acid, phosphorous acid, pyrophosphoric acid, tripolyphosphoric acid, tetrapolyphosphoric acid, trimetaphosphoric acid, phosphoric anhydride, and a derivative of the foregoing.

11. The electrode of claim 1, wherein a thickness of the catalyst layer is about 10 μm to about 100 μm.

12. The electrode of claim 1, wherein the catalyst layer further includes a binder.

13. The electrode of claim 12, wherein the binder comprises at least one selected from a fluorinated polymer, a benzimidazole polymer, polyimide, polyether imide, polyphenylene sulfide, polysulfone, polyethersulfone, polyetherketone, polyether-ether ketone, and polyphenylquinoxaline.

14. The electrode of claim 1, wherein the catalyst comprises at least one element selected from platinum, palladium, ruthenium, iridium, osmium, a platinum-palladium alloy, a platinum-ruthenium alloy, a platinum-iridium alloy, a platinum-osmium alloy, and a platinum-M alloy wherein M is at least one element selected from Ga, Ti, V, Cr, Mn, Fe, Co, Ni, Cu, Ag, Au, Zn, Sn, Mo, W, and Rh.

15. The electrode of claim 14, wherein the catalyst further comprises a carbonaceous support.

16. A membrane electrode assembly for a fuel cell comprising the electrode for the fuel cell of claim 1.

17. The membrane electrode assembly of claim 16, wherein the electrode is a positive electrode.

18. A fuel cell comprising the membrane electrode assembly of claim 16.
